(19) United States
(12) Patent Application Publication
(10) Pub. No.: US 2001/0034649 A1
(43) Pub. Date: Oct. 25, 2001

(54) Method and system for allocating and redeeming tokens

(76) Inventor: John Acres, Corvallis, OR (US)

Correspondence Address: PERKINS COIE LLP, PATENT-SEA, P.O. BOX 1247, SEATTLE, WA, 98111-1247, US

(21) Appl. No.: 09/782,942

(22) Filed: Feb. 14, 2001

Related U.S. Application Data
(60) Provisional application No. 60/182,298, filed on Feb. 14, 2000.
(60) Provisional application No. 60/194,350, filed on Apr. 3, 2000.

(51) Int. Cl. G06F 17/60

(52) U.S. Cl. 705/14

(57) ABSTRACT

A method and system for encouraging users to click through an area of a display by the allocation of tokens. The token allocation technique coordinates the allocation of tokens provided by a token service to users who access web pages of a displaying web site. The displaying web site generates a web page with an advertisement that includes an indication that a token of the token service will be allocated to the user when the user selects (e.g., clicks through) the advertisement. When the user clicks through the advertisement, the token is associated with the user and the advertised web page is displayed.

### CROSS REFERENCE TO RELATED APPLICATION

This application claims the benefit of U.S. Provisional Application No. 60/182,298, entitled “ENHANCING COMMERCIAL ACTIVITIES ON THE INTERNET THROUGH USE OF INCENTIVE AWARDS,” filed Feb. 14, 2000 and U.S. Provisional Application No. 60/194,350, entitled “METHOD AND SYSTEM FOR ALLOCATING AND REDEEMING TOKENS,” filed Apr. 3, 2000, which are hereby incorporated by reference.

### TECHNICAL FIELD

The present invention relates generally to conducting electronic commerce and, more particularly, to allocating tokens to a user who accesses display pages.

### BACKGROUND

Because it facilitates electronic communications between vendors and purchasers, the Internet is increasingly being used to conduct “electronic commerce.” The Internet comprises a vast number of computers and computer networks that are interconnected through communication channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. The World Wide Web portion of the Internet is especially conducive to conducting electronic commerce. Many web servers have been developed through which vendors can advertise and sell product through a web site. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This order information may include the purchaser's name, the purchaser's credit card number, and a shipping address for the order. The server computer system then typically confirms the order by sending a confirming web page to the client computer system and schedules shipment of the items.

The profitability of an e-commerce web site depends in large part on the number of users who visit that web site. To encourage users to visit a web site, the web site may be advertised extensively. The web site may be advertised through traditional media, such as television, radio, and newspaper. The web site may also be advertised on web pages (e.g., via banner ads) generated by another web site. An advertiser may pay a displaying web site that displays their advertisement a certain amount each time that a user accesses a web page of the displaying web site that includes the advertisement. In addition, the advertiser may pay the displaying web site an additional amount each time a user clicks through the advertisement to access a web page of the advertised web site. Finally, the advertiser may pay the displaying web site a referral fee that is a percentage of the price of a purchase that resulted from the click through.

The displaying of advertisements can be very lucrative for a displaying web site. Indeed, some organizations may even pay users to browse the web while advertisements are displayed on a portion of user's display device. These organizations may collect demographic or other information about users so that the advertisements that are appropriate for each user can be selected. The organization may be compensated for each advertisement displayed, for each advertisement that is clicked through, and for each resulting transaction. Such organizations may also encourage users to refer friends and family to sign up with the organization. The referring user may be paid additional amounts if their referred friends and family browse the web while the organizations advertisements are displayed.

The compensation that a web site may receive for displaying an advertisement may be based in part on the perceived appropriateness of the advertisement to the user. For example, an advertisement for an automotive web site may not be appropriate for a ten-year old, but may be appropriate for a 21-year old. The advertisement for the automotive web site may be particularly appropriate to a 21-year old who has just purchased an automobile. Thus, an advertiser would be willing to pay more for advertisements whose appropriateness can be evaluated. Thus, to increase their revenues, organizations collect extensive information about users so that more appropriate advertisements can be presented to the users. The organizations may collect personal data such as age, occupation, gender, income, address, preferences, and shopping habits. These organizations may track the identity of a user using a sign on identification or a cookie stored on the user's computer. This information is so important that some organizations provide incentives (e.g., cash) for users to provide the information, which is then sold to other organizations.

Some web sites offer games (e.g., poker) that users can play to encourage users to visit the web site. As the users play the games, advertisements are displayed. Such gaming web sites may offer substantial prizes to encourage users to play the games and to provide personal information. These gaming web sites may even offer prizes to encourage users to click through the advertisements so that the gaming web site will receive a referral fee. Such gaming web sites are only used by those users who know about the site and who want to play games. Other web sites provide a point service that awards points to users who purchase items at participating web sites. Such point web sites serve as a portal to participating web sites. Thus, the user accesses the participating web site through the points web site to be awarded points. These points can be used to purchase items.

It would be desirable to encourage users to click through advertisements that are displayed on any web page and to encourage users to visit certain web sites so that the revenue of the displaying web site can be increased and traffic through web sites can be increased.

### BRIEF DESCRIPTION OF THE DRAWINGS

FIG. 1 illustrates a web page that displays a token-enabled advertisement.

FIG. 2 illustrates the web page displayed after selection of the advertisement of FIG. 1.

FIG. 3 illustrates the web page displayed after selection of the advertisement of FIG. 2.

FIG. 4 illustrates the web page displayed when the user visits the redemption web site.

FIG. 5 illustrates a web page displayed when the user checks to see if they have won a prize.

FIG. 6 illustrates a web page displayed when a ticket allocated to user is an “instant winner.”

FIG. 7 illustrates a web page that requires a user to enter additional information before redeeming their prize.

FIG. 8 is a block diagram illustrating components used to implement the token service in one embodiment.

FIG. 9 is a block diagram illustrating components of the redemption server.

FIG. 10 is the flow diagram illustrating processing of the allocate tokens component in one embodiment.

FIG. 11 is a flow diagram illustrating processing of the redeem tokens component in one embodiment.

### DETAILED DESCRIPTION

A method and system for encouraging users to click through an area of a display by the allocation of tokens is provided. In one embodiment, the token allocation technique coordinates the allocation of tokens provided by a token service to users who access web pages of a displaying web site. The displaying web site generates a web page with an advertisement that includes an indication that a token of the token service will be allocated to the user when the user selects (e.g., clicks through) the advertisement. When the user clicks through the advertisement, the token is associated with the user and the advertised web page is displayed. Each token may have a value associated with it. For example, a token token may represent a currency based value, a non-currency based value, a ticket number, and so on. The token service may allow users to accumulate tokens. Users may redeem their tokens at a redemption web site provided by the token service. The redemption web site may allow the user to play games with tokens, trade the tokens for prizes, use the tokens to buy items, and so on. Alternatively, the redemption web site may notify the user that a prize has been won at the time a token is allocated (e.g., an “instant winner”). The indication that a will be allocated may be a graphic image that is included with the advertisement, a sound that is output when the advertisement is displayed, or any other way in which a user can be notified that a token will be allocated for clicking through the advertisement. Such advertisements are referred to as “token-enabled” advertisements. As users become accustomed to the token-enabled advertisements, the users will be more likely to click through such advertisements. Also, the token service may allocate tokens to users for accessing various token-enabled web pages or web sites. A token-enabled advertisement may be for a token-enabled or a nontoken-enabled web site, and a nontoken-enabled advertisement may be for a token-enabled web site. Because the token service may allow any web site to use token-enabled advertisements, users do not have to access a certain gaming web site to be allocated tokens.

The token service may implement token allocation using a web page component and a redemption web site. A displaying web site that displays a token-enabled advertisement generates a web page that includes the advertisement along with an indication that the advertisement is token-enabled and then sends the web page to a user's computer. (The web page may include a link to an advertising server that provides the token-enabled advertisement.) When the web page is displayed and the user selects the advertisement, the web page component adds a message to the advertised web site. The message may include an identification of the user or the user's computer (e.g., retrieved from a cookie). The advertised web site may then notify the redemption web site to allocate a token to the identified user and then send their web page to the user's computer. The following alternative approaches for notifying the redemption web site have the characteristic that the advertised web site might not need to be aware of the token service. The token service may keep track of the tokens allocated to user by storing information on the user's computer. In response to a selection of a token-enabled advertisement, the web page component of web page that is displaying the advertisement may store information on the user's computer to indicate that the token has been allocated to the user. For example, the web page component may cause a token counter on the user's computer to be incremented. As another alternative approach, the user's computer may have a notification component (e.g., an applet downloaded along with the web page or a plug-in previously installed on the user's computer) that sends a notification directly to the redemption web site when the advertisement is selected by the user. As another alternative approach, the URL to the web site associated with the advertisement can point to the redemption web site when the web page is generated. The redemption web site could then track the token allocation as advertisements are selected and then redirect the user's computer to retrieve the next web page from the advertised web site. When a notification is sent to the redemption web site either by the notification component or by the URL that points to the redemption web site in response to the advertisement being selected, that notification may include an identifier of the user that was previously stored in a cookie by the redemption web site. When the redemption web site receives the notification, it can update the count of tokens allocated to the identified user. In this way, the count of allocated tokens needs not be stored on the user's computer.

Tokens may be redeemed through a redemption web site, a physical store, a telephone service, or any other mechanism through which tokens can be redeemed. The users may redeem their tokens for various items, such as gift certificates, or may use their tokens to play various games, such as solitaire or a lottery. A redemption web site may track the tokens that have been allocated to the user for any reason. The token service may allocate tokens to users for reasons other than selecting advertisements. For example, tokens may be allocated to a user that registers with the redemption web site, that provides additional personal information, that provides information about friends and family, that accesses a token-enabled web page or web site, and so on.

The token service may use various techniques to encourage users to select token-enabled advertisements. The token service may encourage continued selection of advertisements by increasing the value of tokens associated with an advertisement that is displayed to a user who, for example, has selected advertisements in each of the last five days. The token service may change the value of tokens based on the time of day or time of year, based on the affiliation of the user, based on the personal information of the user, or based on the displaying web site or the advertised web site. For example, a user who is a member of a certain credit union may receive an increased token value. The token value associated with an advertisement may be also based on the amount of money the advertiser will pay for selection of the advertisement or the amount of money the displaying web site will pay to token-enable an advertisement. The token service may also allocate additional tokens to a user, who after selecting a token-enabled advertisement, conducts a transaction with the advertiser (e.g., purchases an item). The token service may associate an expiration date or time with the token value to encourage users to redeem their tokens quickly to increase traffic through the redemption web site. The token service may also increase the token value if the user has visited certain web sites. For example, it may be advertised that if a user selects a certain advertisement, then the token value associated with the next five token-enabled advertisements that are displayed to the user or selected by the user will be doubled. This will encourage the user to not only select that certain advertisement, but also to view or select five additional advertisements. The value of the token may be based in part upon its expiration date. For example, a long-lived token is more valuable than a short-live token. Also, the token allocation system may have different categories of tokens. For example, one category of tokens may be redeemable for cash prizes, another category of tokens may be redeemable for gift certificates, and then another category of tokens may be may be used to play games. Also, various organizations may sponsor funding events using the token service. For example, a logo for an organization (e.g., college) may be displayed in association with a token-enabled advertisement. Every time a user affiliated with the organization clicks through such an advertisement, a token is allocated to the organization, which may be redeemable for cash.

The token service may allow a user to participate without advanced registration and with anonymity. The token service may associate an identifier with a user or user's computer. Such an identifier may be a browser serial number, computer serial number, randomly generated number, and so on. The identifier may be stored as a cookie on the user's computer. In this way, any user may start using the token service without the need to pre-register and with relative anonymity.

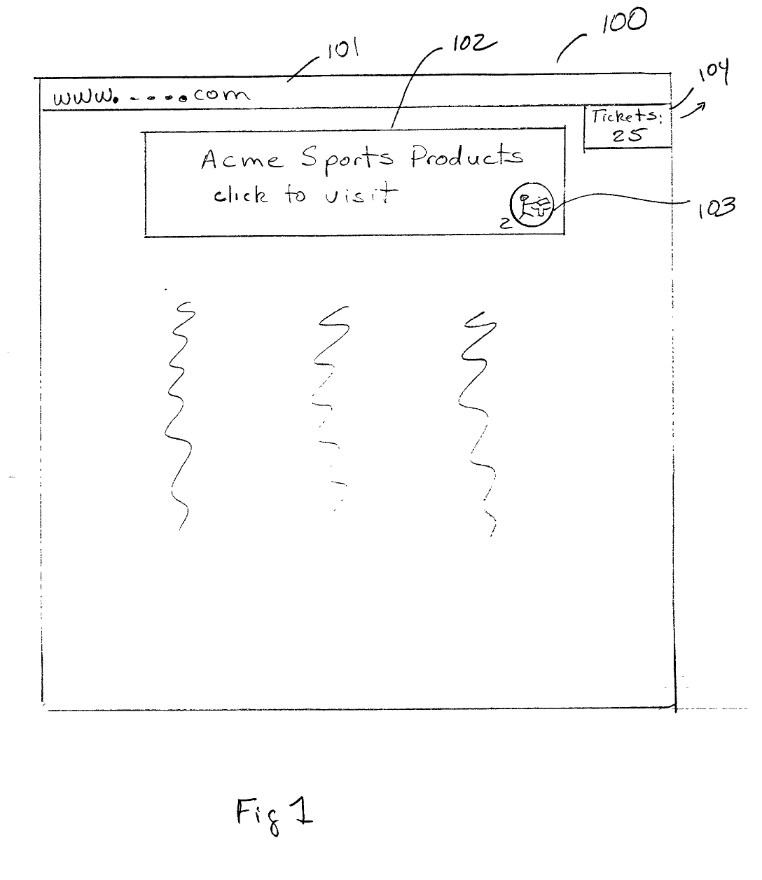

FIGS. 1-7 are web pages illustrating usage of the token service in one embodiment. In this embodiment, the tokens represent tickets for a lottery and each ticket has the same value. The value of an allocation is increased by allocating more tickets. FIG. 1 illustrates a web page that displays a token-enabled advertisement. The web page 100 includes an address line 101, an advertisement 102 with a token logo 103, and a ticket counter 104. The address line indicates the address (e.g., URL) of the displayed web page. The token logo indicates that the advertisement is token enabled. In this example, the logo is suggestive of someone pulling a ticket out of a hat. The token logo may also include an indication of the number of tickets (i.e., value of the token) that will be allocated to the user upon selection of the advertisement. For example, the “2” to the left of the token logo indicates that two tickets will be allocated when the advertisement is selected. The ticket counter indicates the number of tickets “25” that are currently allocated to the user. The ticket counter may be implemented as a URL to the redemption web site that is added when the web page is generated. The user's browser resolves this URL by sending an HTTP-request message to the redemption web site and receiving an HTTP-response message indicating the user's current ticket allocation in return. Alternatively, the allocation may be stored persistently on the user's computer using a cookie or some other mechanism. Alternatively, the ticket counter may be implemented as a plug-in to the user's browser. When the user selects the advertisement, the web page associated with that advertisement is displayed and the user is allocated two tickets. In this embodiment, when the advertisement is selected, an HTTP-request message is sent to the advertised web site as indicated by the URL associated with the advertisement. The HTTP-request message contains an identifier of the user along with an indication of two tickets. The advertised web site sends a web page to the user's computer and notifies the redemption web site to allocate two tickets to the user.

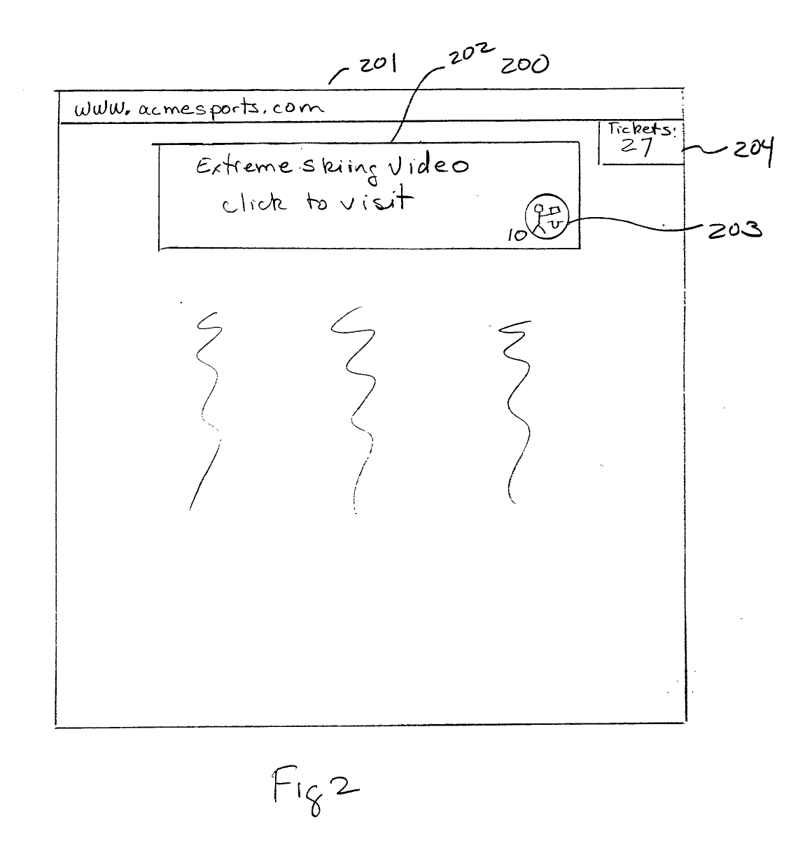

FIG. 2 illustrates the web page displayed after selection of the advertisement of FIG. 1. The web page 200 includes an address line 201, an advertisement 202 with a token logo 203, and a ticket counter 204. The address line indicates that the advertised web site is “acmesports.com.” The ticket counter displays a value of “27” to reflect that two tickets were allocated to the user as a result of selecting the advertisement for “acmesports.com” of FIG. 1. The advertisement 202 is for a specific video that is offered for sale by “acmesports.com.” The token logo indicates that 10 tickets will be allocated to the user if the advertisement is selected. The advertiser may have decided that this particular user has recently purchased a pair of high-performance skis and thus is providing an increased incentive for the user to access a web page which the video can be purchased. This web page illustrates an alternative use of the token service that is within a merchants own web site to encourage users to visit other web pages within that web site.

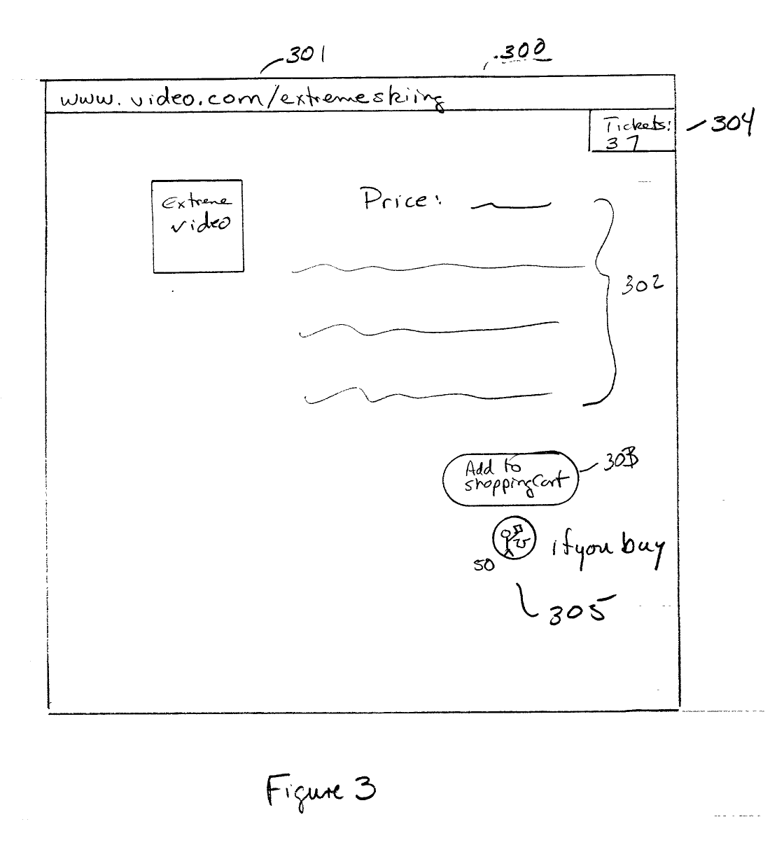

FIG. 3 illustrates the web page displayed after selection of the advertisement of FIG. 2. The web page 300 includes an address line 301, a description of the video along with pricing information 302, an add-to-shopping-cart button 303, a ticket counter 304, and a token logo 305. The ticket counter displays a value of “37” which indicates that 10 tickets were allocated to the user by selection of the advertisement of FIG. 2. The user may use the add-to-shopping-cart button to purchase the item. The token logo 305 indicates that 50 tickets will be allocated to the user if the user purchases the video, which illustrates another use of the token service.

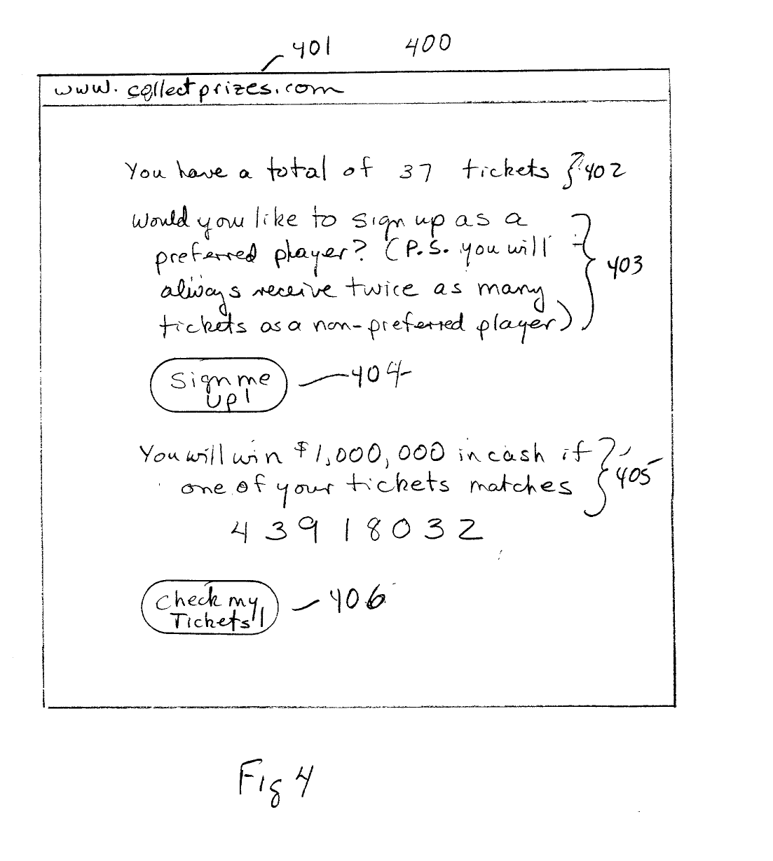

FIG. 4 illustrates the web page displayed when the user visits the redemption web site. The web page 400 includes an address line 401, a ticket counter 402, an invitation to register 403, a sign-up button 404, a prize description 405, and a check tickets button 406. The address line indicates that the address of the redemption web site is “collectprizes.com.” The ticket counter indicates that the user has accumulated a total of “37” tickets. The invitation to register area indicates that if the user registers, the user will be allocated twice as many tickets in the future. The user selects the signed up button to register. The prize description indicates that the user will receive $1,000,000 if one of the tickets allocated to the user matches “43918032.” The user selects the check ticket button to determine whether they have won a prize.

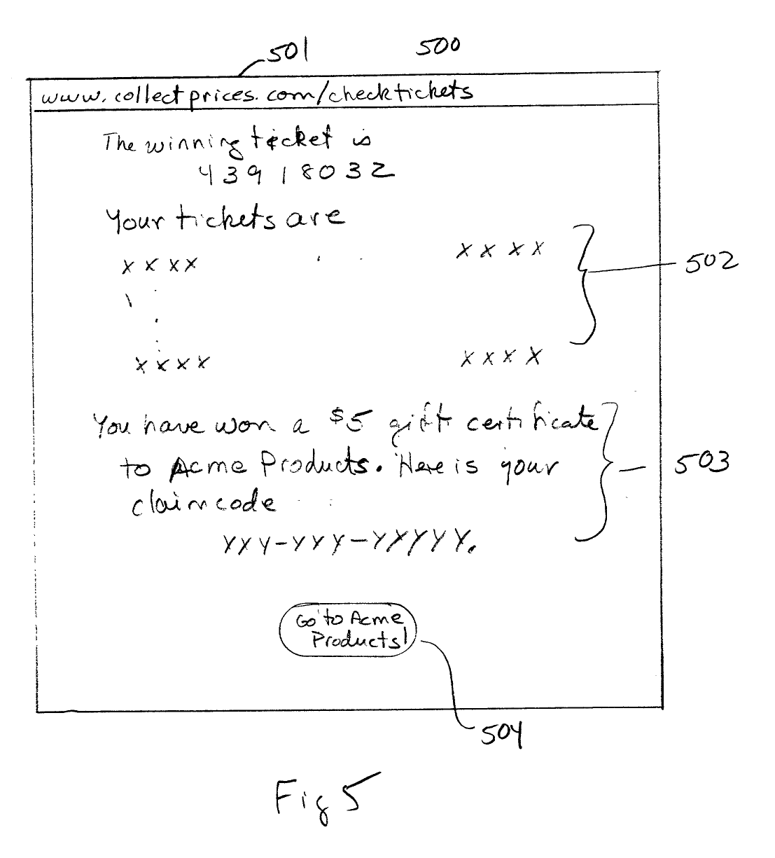

FIG. 5 illustrates a web page displayed when the user checks to see if they have won a prize. The web page 500 includes an address line 501, a ticket number area 502, a prize notification area 503, and a navigation button 504. The ticket number area lists the numbers of the 37 tickets that are allocated to the user. In this example, the user did not win the $1,000,000 prize. Rather, as the prize notification area indicates, the user has won a $5 gift certificate for use at the “acmeproducts.com” web site. The user can navigate directly to the “acmeproducts.com” web site using the navigation button.

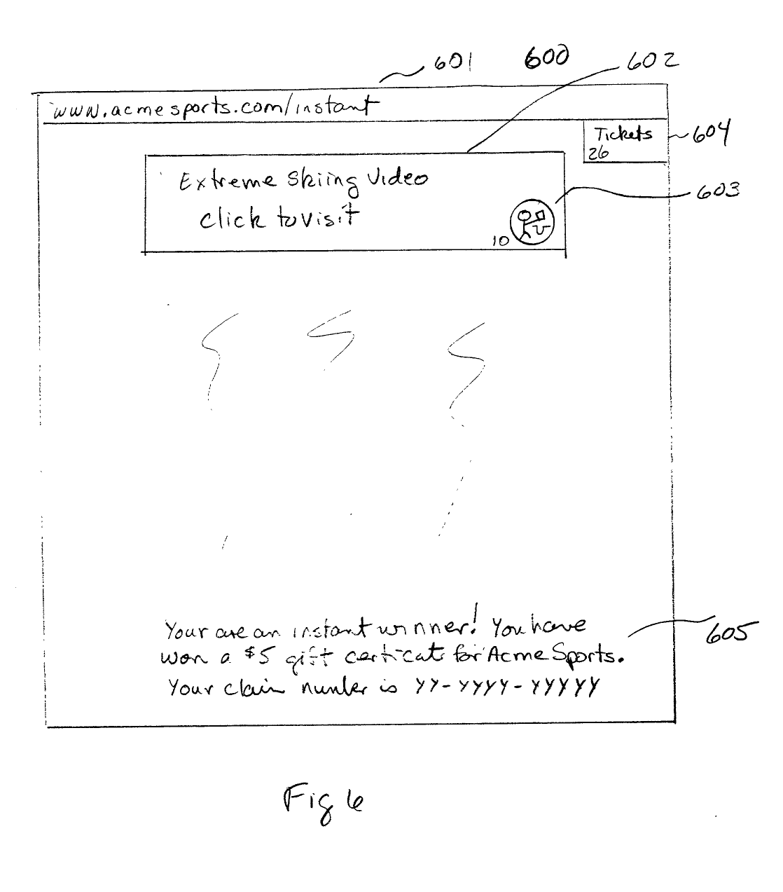

FIG. 6 illustrates a web page displayed when a ticket allocated to user is an “instant winner.” The web page 600 includes an address line 601, an advertisement 602 with token logo 603, a ticket counter 604, and an instant winner notification 605. In this example, the user who selected the advertisement of FIG. 1 was allocated two tickets. The redemption web site determined that one of the tickets was an “instant winner.” In response to notifying the redemption web site to allocate the user two tickets, the advertised web site received an indication that one of the tickets was an instant winner. The advertised web site then generated this web page with the instant winner notification. The instant winner notification area indicates that the user has won a $5 gift certificate. The instant winner notification may alternatively be displayed in a separate web page or in a pop-up window.

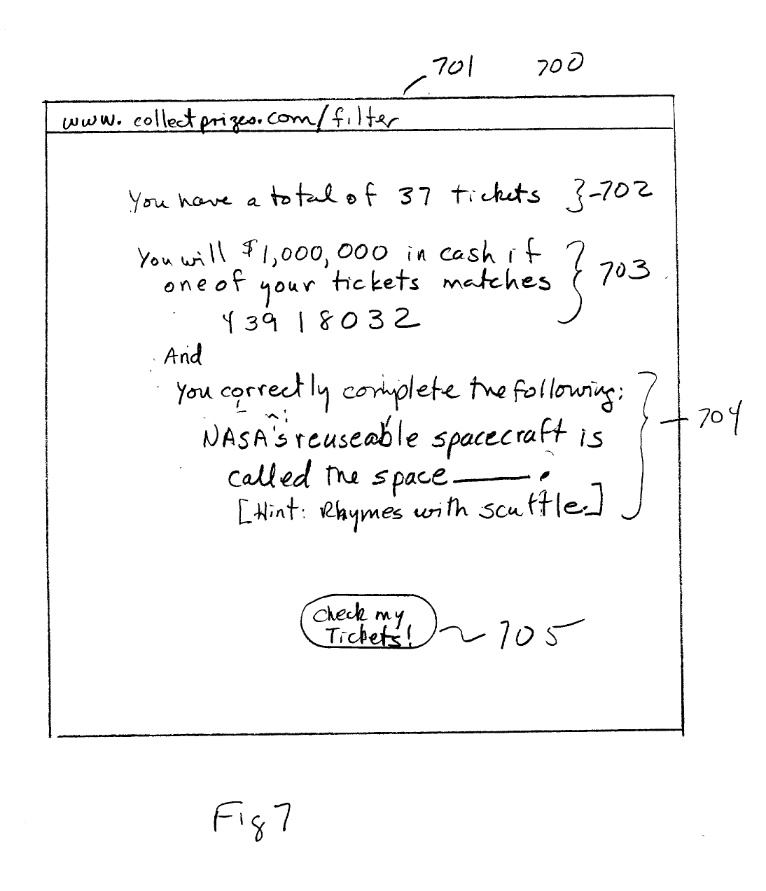

FIG. 7 illustrates a web page that requires a user to enter additional information before redeeming their prize. The web page 700 includes an address line 701, a ticket counter 702, a prize notification area 703, an information area 704, the check tickets button 705. In this example, the redemption web site requires that a user enter some information prior to redeeming their tickets. The information may be entered for a variety of reasons. For example, the token service may want to add entertainment value by asking certain questions or to reduce the number of winners by making the redemption contingent on the user correctly answering a difficult question. Alternatively, the token service may want to make it difficult for automated systems to be allocated and redeem tickets. To help prevent the use of such automated systems, the redemption web site may randomly select simple questions from a very large set of questions. Most users would be anticipated to know the answers to these questions, but it would be difficult to develop an automated system that would know the answers.

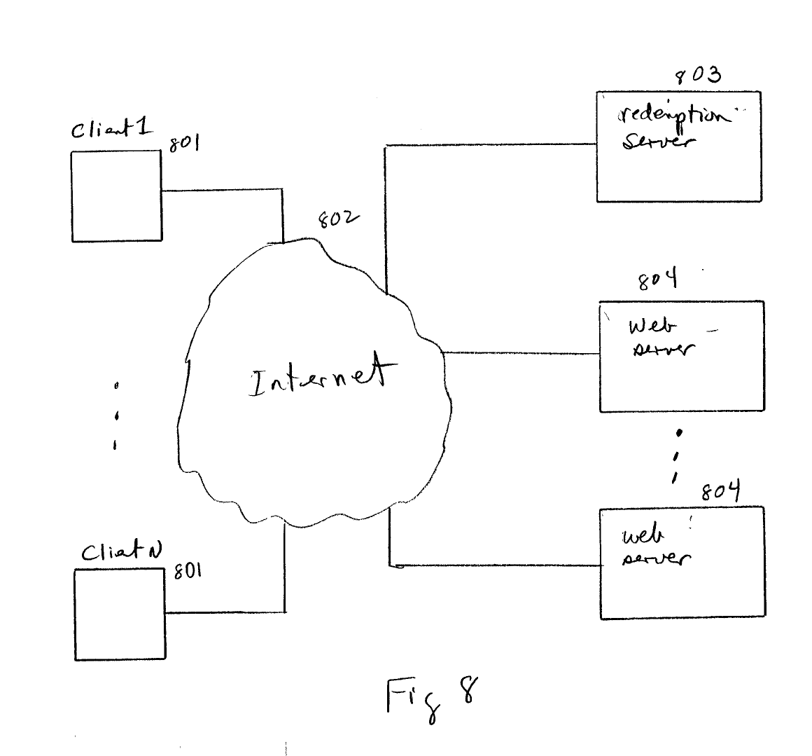

FIG. 8 is a block diagram illustrating components used to implement the token service in one embodiment. The client computers 801, the redemption server 803, and various web servers 804 are interconnected via the Internet 802. The computers may include a central processing unit, memory, input devices (e.g., keyboard and pointing device), output devices (e.g., display devices), and storage devices (e.g., disk drive). The memory and storage devices are computer-readable media that may contain computer instructions that implement the token service. In addition, the data structures and message structures may be stored or transmitted via a computer-readable medium, such as a communications link. Also, various communication channels other than the Internet may be used, such as a local area network, a wide area network, or a point-to-point dial-up connection. The computer systems may comprise any combination of hardware and software that can support web servers and browsers. In particular, a web server may actually include multiple computers. The client systems may comprise any combination of hardware software that interacts with server systems. The client computers may use browsers to access web pages of the servers via the Internet. The client systems may include television-based systems and various other consumer products to which information can be communicated. Moreover, the concepts of the token service may be applied to business methods that are not supported by computer systems or only partially supported by computer systems. Also, a company may encourage its employees to view a certain web page by allocating tokens to the employees who select that web page. The tokens can then be redeemed for prizes. One skilled in the art will appreciate that the concepts of the token service can be used in many different environments. For example, an electronic mail message may contain an advertisement with a token logo. When a user selects a URL associated with that advertisement, a token is allocated to the user. Also, an advertisement may be displayed on a cellular phone. When the user dials a telephone number associated with that advertisement, the token service may allocate tokens to the user. As another example, a radio advertisement may identify a token code. The user may then enter that token code at a certain web site to be allocated tokens. A user may redeem their tokens by actually traveling to a certain location, such as a store in their community.

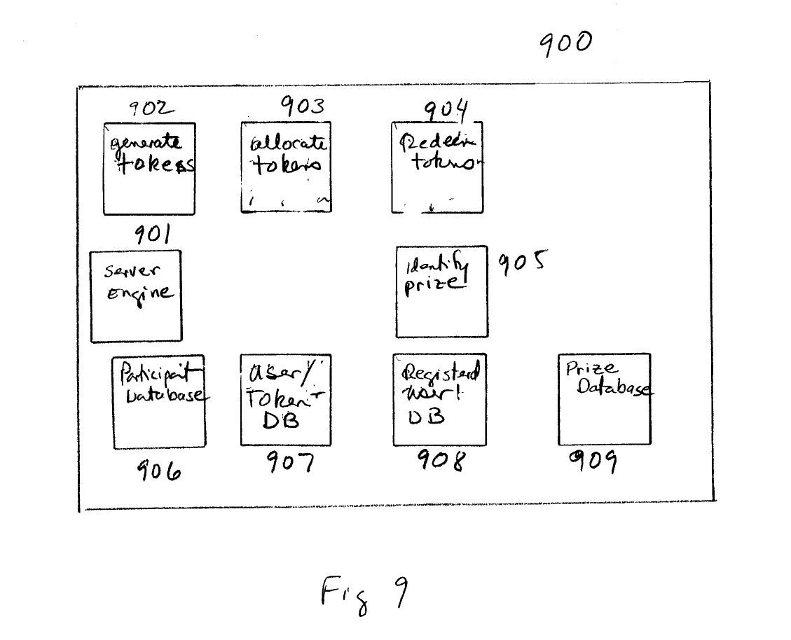

FIG. 9 is a block diagram illustrating components of the redemption server. The server 900 includes a server engine 901, a generate tokens component 902, an allocate tokens component 903, a redeem tokens component 904, an identify prize component 905, a participant database 906, a user/token database 907, a registered user database 908, and a prize database 909. The server engine receives HTTP-request messages and coordinates the preparation of the HTTP-response messages. The generate tokens component receives requests to generate tokens to be assigned to an advertisement and responds with an indication of the token value. The request may identify the user to whom the advertisement is to be displayed, the advertisement, and the displaying web site. The generate token component may use various algorithms to select a token value. For example, the algorithm may include doubling the token value if the user is registered, if the same user has selected at least one advertisement the day before, if the user is affiliated with a certain group, or if the request arrived during a certain time of day. One skilled in the art will appreciate that many different algorithms may be used to provide incentives to achieve various objectives. The generate token component may persistently store information relating to the token generation to track the effectiveness of the token service. When a web page is generated by a displaying web site, that web page may contain a link to the redemption web site for retrieving the token value currently allocated to a user. When the web page is displayed, the user's computer sends an HTTP-request message to the redemption web site and receives an indication of the token value allocated to that user in return.

The allocate tokens component receives messages indicating that tokens are to be allocated to a user. The messages may be sent by the user's computer or by an advertised web site. The message may contain the identification of the user and the token value to be allocated. The message may contain additional information such as the identity of the advertised web site and the identity of displaying web site. The allocate tokens component updates the information for that user in the user/token database. The redeem tokens component receives a request from a user to redeem tokens. The redeem tokens component retrieves the token value allocated to that user from the user/token database. The component adds an indication of the possible prizes to a web page and sends the generated web page to the user. The redeem tokens component may also invoke the identify prize component to identify the prize to be awarded the user. The identify prize component implements the algorithm used to identify a prize to be awarded to the user. For example, the algorithm may generate a random ticket number and compare that random ticket number to the ticket numbers allocated to the user. The component may allow the user to browse through a catalog of items that can be purchased with tokens. The component may also implement various games by which the user can expend and receive tokens by playing. The identify prize component may base the size of the prize on the number of tokens allocated so that the prize grows as more users use the token service. The participant database contains information describing each of the displaying web sites and possibly advertised web sites. This information may identify each web page that displays a token-enabled advertisement along with the identification of the user, the displaying web site, and the advertised web site. The user/token database contains the value of the tokens that have been allocated to each user. Each user can be uniquely identified by a number generated by the redemption web site. In addition or alternatively, token allocations may be stored on the user's computer. The registered user database contains information relating to each user who has registered with redemption server. The prize database contains a description of items that may be purchased with the tokens. Each item in the database may have a token value associated with it. Additionally, the prize database may contain tables describing various promotions. For example, the prize database may contain information indicating that members of a certain credit union are eligible for certain types of prizes.

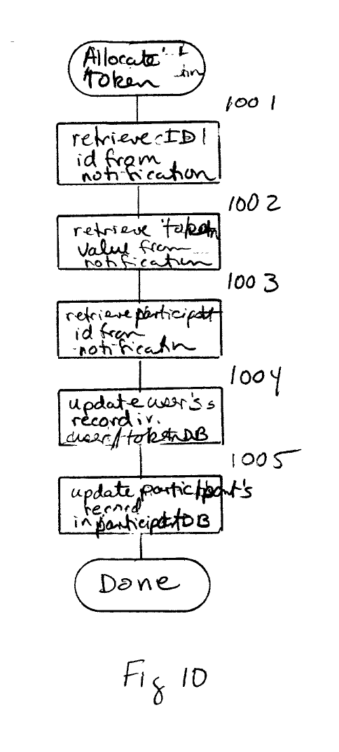

FIG. 10 is the flow diagram illustrating processing of the allocate tokens component in one embodiment. In block 1001, the component retrieves the user identifier from the notification (e.g., stored in the cookie), which may be an HTTP-request message. If no user identifier is included in the notification, then the component generates a new user identifier and returns that user identifier so that it can be stored at the user's computer. (User identifiers may be assigned by the generate tokens component.) Subsequent selection of a token-enabled advertisement will result in that identifier being transmitted to the redemption web site. In block 1002, the component retrieves the token value from the notification. The component may verify that the token value corresponds the token value that was assigned to the advertisement for that user. In block 1003, the component retrieves the participant's identifier from the notification. In block 1004, the component updates the user's record in the user/token database to reflect the new allocation. In block 1005, the component updates the participant's records in the participant database and then completes.

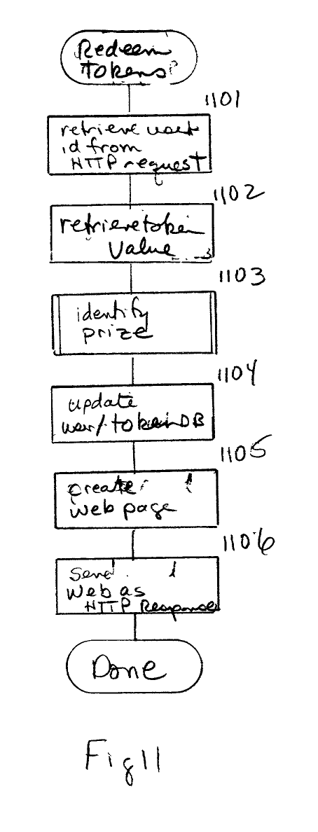

FIG. 11 is a flow diagram illustrating processing of the redeem tokens component in one embodiment. This component may be used to process an HTTP-request for a web page through which a user can redeem tokens. In block 1101, the component retrieves the user identifier from the HTTP-request message. The component may verify that the user identifier is valid. In block 1102, the component uses the user identifier to retrieve the token value for that user from the user/token database. In block 1103, the component performs the identify prize algorithm to identify the prize to be awarded to the user. In block 1104, the component updates the user/token database to reflect the redemption of the tokens. In block 1105, the component creates a web page that indicates the prize that has been awarded to the user. In block 1106, the component sends the generated web page to the user and then completes.

From the foregoing it will be appreciated that although specific embodiments of the invention have been described herein for purposes of illustration, various modifications may be made without deviating from the spirit and scope of the invention. The token service may have various sources of revenue. For example, revenues may be generated from advertisements displayed on the redemption web site, from displaying web sites that present token-enabled advertisements, and from token-enabled web sites. Accordingly, the invention is not limited except by the appended claims.

1. A method in a computer system for allocating tokens, the method comprising:
receiving a web page from a displaying web site, the web page having an area that is associated with a token;
displaying the received web page with the area; and
in response to selection of the displayed area by a user,
associating the token with the user; and
requesting a web page that is identified by the area
wherein the user can redeem the token that has been associated with the user by visiting a redemption web site that is separate from the displaying web site.

2. The method of claim 1 wherein the area includes an advertisement.

3. The method of claim 1 wherein the area includes an indication that a token will be associated with the user upon selection of the area.

4. The method of claim 3 wherein the indication is a graphic image.

5. The method of claim 1 including requesting a display page through which a user can redeem the token.

6. The method of claim 1 wherein the associating of the token with the user includes notifying a redemption server that the user has selected the area.

7. The method of claim 6 wherein the notifying of the redemption server includes sending a message directly to the redemption server.

8. The method of claim 6 wherein the notifying of the redemption server includes sending a message to the redemption server indirectly through a server that is requested to provide the web page identified by the area.

9. The method of claim 1 wherein the associating of the token with the user includes persistently storing an indication of the association of the token with the user on the computer system.

10. The method of claim 1 wherein the token expires if a certain condition is not satisfied.

11. The method of claim 10 wherein the condition is redemption of the token within a time period.

12. The method of claim 10 wherein the condition is visiting another site within a time period.

13. The method of claim 1 wherein the associating of the token with the user includes accumulating the number of tokens associated with the user.

14. The method of claim 1 wherein the associating of the token with the user includes associating multiple tokens with the user.

15. The method of claim 14 wherein the number of tokens associated with the user increases when a condition is satisfied.

16. The method of claim 15 wherein the condition is based on frequency of selection of areas associated with a token.

17. The method of claim 15 wherein the condition is affiliation of the user with a group.

18. The method of claim 15 wherein the condition is based on demographics of the user.

19. The method of claim 15 wherein the condition is based on analysis of past access patterns of the user.

20. The method of claim 15 wherein the condition is based on whether the user has registered with a token service.

21. The method of claim 15 wherein the condition is based on time of day.

22. The method of claim 15 wherein the condition is based on time of year.

23. The method of claim 15 wherein the condition is based on information content of the area.

24. The method of claim 1 including receiving notification of redemption of the token in response to selection of the area.

25. The method of claim 1 wherein the user is prompted to provide information that is selected to reduce the chances of an automated system providing the information.

26. The method of claim 25 wherein the information is entered within a sub-area of the area.

27. The method of claim 1 including prohibiting the association of a token with a user when a condition is satisfied.

28. The method of claim 27 wherein the condition is based on tokens previously allocated to the user.

29. A method in a computer system for redeeming tokens through a redemption web site, the method comprising:
allocating tokens to a user in response to receiving a selection notification that the user has selected an advertisement on a web page that is generated by a separate web site that is different from the redemption web site;
receiving a request for token redemption, the request including an indication of the user;
in response to receiving the request, retrieving an indication of one or more tokens associated with the user;
identifying a prize to award based on the retrieved indication of the one or more tokens; and
sending a prize notification to the user of the identified prize.

30. The method of claim 29 wherein the request is received in response to the user selecting the advertisement.

31. The method of claim 29 wherein the prize notification indicates that the user is an instant winner.

32. The method of claim 29 wherein the selection notification is received from a computer of the user.

33. The method of claim 29 wherein the selection notification is received from a computer that provides a web page in response to selection of the advertisement.

34. The method of claim 29 including before sending the prize notification, requesting that the user enter answer a question.

35. The method of claim 29 including before sending the prize notification, providing a game for the user to play.

36. The method of claim 35 wherein the identified prize depends on an outcome of the game.

37. The method of claim 29 wherein the allocating of tokens adjusts a value of the tokens allocated based on time of day when the advertisement was selected.

38. The method of claim 29 wherein the allocating of tokens adjusts a value of the tokens allocated based an affiliation of the user.

39. The method of claim 29 wherein the allocation of tokens adjusts a value of the tokens allocated based on revenue derived from an advertiser.

40. The method of claim 29 wherein the allocation of tokens adjusts a value of the tokens allocated based on web site access patterns of the user.

41. The method of claim 29 wherein the allocation of the tokens expire after a time period.

42. A computer system for allocating tokens, comprising:
means for receiving a web page from a displaying web site, the web page having an area that is associated with a token;
means for displaying the received web page with the area;
means for allocating the token to the user and requesting a web page that is identified by the area in response to selection of the displayed area by a user
wherein the token that has been allocated to the user can be redeemed at a redemption web site that is separate from the displaying web site.

43. A computer-readable medium containing a web page, the web page comprising an advertisement with an associated token wherein, when a user selects the advertisement, the token is allocated to the user, and wherein the user can redeem the allocated token at a redemption web site that is separate from a displaying web site that provides the web page.

44. A computer-readable medium containing instructions for controlling a computer system to allocate tokens, by a method comprising:
receiving a web page from a displaying web site, the web page having an advertisement that is associated with a token;
displaying the received web page with the advertisement; and
in response to selection of the displayed advertisement by a user, allocating the token to the user
wherein the user can redeem the allocated token by visiting a redemption web site that is separate from a displaying web site that provides the web page.

45. A method in a computer system for generating a web page by a displaying web site, the method comprising adding to the web page an advertisement, the advertisement associated with a token wherein when a user selects the advertisement, the associated token is allocated to the user and wherein the user can redeem the token by visiting a redemption web that is different from the displaying web site.

46. The method of claim 45 wherein the redemption web site and the displaying web site are controlled by different entities.

47. The method of claim 46 wherein the entities are companies.

48. The method of claim 45 wherein the displaying web site adds a link to the web page that indicates the advertisement is to be retrieved from an advertising server.
